(19) United States
(12) Patent Application Publication
(10) Pub. No.: US 2023/0052231 A1
(43) Pub. Date: Feb. 16, 2023

(54) Subject-Level Granular Differential Privacy in Federated Learning

(71) Applicant: Oracle International Corporation, Redwood City, CA (US)

(72) Inventors: Virendra J. Marathe, Florence, MA (US); Pallika Haridas Kanani, Westford, MA (US)

(21) Appl. No.: 17/663,009

(22) Filed: May 11, 2022

Related U.S. Application Data
(60) Provisional application No. 63/227,840, filed on Jul. 30, 2021.

(51) Int. Cl. G06N 20/20; G06F 21/62

(52) U.S. Cl. CPC G06N 20/20; G06F 21/6245

(57) ABSTRACT

Group-level privacy preservation is implemented within federated machine learning. An aggregation server may distribute a machine learning model to multiple users each including respective private datasets. The private datasets may individually include multiple items associated with a single group. Individual users may train the model using their local, private dataset to generate one or more parameter updates and to determine a count of the largest number of items associated with any single group of a number of groups in the dataset. Parameter updates generated by the individual users may be modified by applying respective noise values to individual ones of the parameter updates according to the respective counts to ensure differential privacy for the groups of the dataset. The aggregation server may aggregate the updates into a single set of parameter updates to update the machine learning model.

### BACKGROUND

This application claims benefit of priority of U.S. Provisional Patent Application No. 63/227,840, filed Jul. 30, 2021, which is hereby incorporated by reference herein in its entirety.

### FIELD OF THE DISCLOSURE

This disclosure relates generally to computer hardware and software, and more particularly to systems and methods for implementing federated machine learning systems.

### DESCRIPTION OF THE RELATED ART

Federated Learning (FL) has increasingly become a preferred method for distributed collaborative machine learning. In Federated Learning, multiple users collaboratively train a single global machine learning model using respective private data sets. These users, however, do not share data with other users. A typical implementation of Federated Learning may contain a federation server and multiple federation users, where the federation server hosts a global machine learning model and is responsible for distributing the model to the users and for aggregating model updates from the users.

The respective federation users train the received model using private data. While the isolation of this private data is a first step toward ensuring data privacy, machine learning models are known to learn the training data itself and to leak that training data at inference time.

There exist methods based on Differential Privacy (Differential Privacy) that ensure that individual data items are not learned by the Federated Learning trained model, however the private data of multiple federation users may include information about a single individual. In order to protect an individual's data, the Federated Learning system must enact a Differential Privacy enforcement mechanism for individuals.

### SUMMARY

Methods, techniques and systems for implementing subject-level privacy preservation within federated machine learning. An aggregation server may distribute a machine learning model to multiple users each including respective private datasets. The private datasets may individually include multiple items associated with a single subject. Individual users may train the model using the local, private dataset to generate one or more parameter updates and determine a count of the largest number of items associated with any single subject of a number of subjects in the dataset. Parameter updates generated by the individual users may be modified by applying respective noise values to individual ones of the parameter updates according to the respective counts to ensure differential privacy for the subjects of the dataset. The aggregation server may aggregate the updates into a single set of parameter updates to update the machine learning model. The methods, techniques and systems may further include iteratively performing said sending, training, determining, modifying, aggregating and updating steps.

### BRIEF DESCRIPTION OF THE DRAWINGS

FIG. 1 is a block diagram illustrating a collaborative, federated machine learning system that enables multiple users to cooperatively train a machine learning model without sharing private training data, in various embodiments.

FIG. 2 is a block diagram illustrating a machine learning system that functions as a user of a collaborative, federated machine learning to cooperatively train a machine learning model without sharing private training data, in various embodiments.

FIG. 3 is a block diagram illustrating an embodiment implementing a federated machine learning system providing centralized subject-level Differential Privacy (Differential Privacy), in various embodiments.

FIG. 4 is a block diagram illustrating another embodiment implementing a federated machine learning system providing subject-level local Differential Privacy (Differential Privacy), in various embodiments.

FIG. 5 is a block diagram illustrating one embodiment of a computing system that is configured to implement position-independent addressing modes, as described herein.

While the disclosure is described herein by way of example for several embodiments and illustrative drawings, those skilled in the art will recognize that the disclosure is not limited to embodiments or drawings described. It should be understood that the drawings and detailed description hereto are not intended to limit the disclosure to the particular form disclosed, but on the contrary, the disclosure is to cover all modifications, equivalents and alternatives falling within the spirit and scope as defined by the appended claims. Any headings used herein are for organizational purposes only and are not meant to limit the scope of the description or the claims. As used herein, the word “may” is used in a permissive sense (i.e., meaning having the potential to) rather than the mandatory sense (i.e. meaning must). Similarly, the words “include”, “including”, and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. § 112(f) interpretation for that unit/circuit/component.

This specification includes references to “one embodiment” or “an embodiment.” The appearances of the phrases “in one embodiment” or “in an embodiment” do not necessarily refer to the same embodiment, although embodiments that include any combination of the features are generally contemplated, unless expressly disclaimed herein. Particular features, structures, or characteristics may be combined in any suitable manner consistent with this disclosure.

### DETAILED DESCRIPTION OF EMBODIMENTS

Federated Learning is a distributed collaborative machine learning paradigm that enables multiple users to cooperatively train a machine learning model without sharing private training data. A typical Federated Learning framework may contain a central federation server and numerous federation users connected to the server. The users train a common machine learning model using private training data and send resulting model updates to the server. The server may then aggregate incoming model updates, update the model and broadcast the updated model back to the users. This process may then repeat for several training rounds until the model converges or a fixed number of rounds is complete.

Federated Learning leverages collective training data spread across all users to deliver better model performance while preserving privacy of each user's training data by locally training the model at the user. However, using Federated Learning, the resulting model may expose information about the training data at inference time. Differential Privacy (Differential Privacy), a provable privacy guarantee, may be added to Federated Learning to address this shortcoming.

In machine learning model training, Differential Privacy may ensure that the impact of each individual training data item on the resulting machine learning model is bounded by a privacy loss parameter. A sufficiently low privacy loss parameter may guarantee that no adversary may determine the presence (or absence) of any data item in the training data.

With Federated Learning, privacy may be enforced at the granularity of each data item, thus obfuscating the use of each item in the aggregate training dataset (across all users). Privacy may also be enforced at the granularity of each federation user, therefore obfuscating the participation of each user in the training process. The former is termed item-level privacy and the latter user-level privacy.

However, there exists a third granularity of privacy, subject-level privacy, where a subject is an individual whose private information is embodied in several data items either confined within a single federation user or distributed across multiple federation users. Neither item-level nor user-level privacy are sufficient to enforce subject-level privacy.

Subject-level Differential Privacy may be enforced either globally, by the federation server, or locally, by each user before sending model updates to the server. In the context of Federated Learning, the global enforcement may be termed global Differential Privacy while local enforcement many be termed local Differential Privacy.

The preferred approach, either global Differential Privacy or local Differential Privacy, may be guided by assumptions made about the trust model between the federation server and its users. Global Differential Privacy may be preferred in cases where the users trust the federation server, whereas local Differential Privacy may be preferred in cases where there is a lack of trust between users and the federation server, or where lack of trust between users and the federation server must be assumed.

For machine learning model training, Differential Privacy may be introduced in the model by adding carefully calibrated noise during training. In the Federated Learning setting, this noise may be calibrated to hide either the use of any individual data item, called item-level privacy, or the participation of any user, called user-level privacy. User-level privacy is generally understood to be a stronger privacy guarantee than item-level privacy since the former hides use of all data of each user, whereas the latter may leak the user's data distribution even if it individually protects each data item.

Item or user-level privacy may be appropriate privacy granularities in some applications. However, applications where federation users are organizations that are, themselves, gatekeepers of data items of numerous individuals or subjects offer much richer mappings between those subjects and their personal data.

Item-level privacy may not, in these applications, be sufficient to protect privacy of a subject's data because item-level privacy simply obfuscates participation of individual data items in the training process. Since a subject may have multiple data items in the dataset, item-level private training may still leak a subject's data distribution. User-level privacy may not protect the subject's privacy either. User-level privacy obfuscates each user's participation in the training process. However, a subject's data may be distributed among several users. In the worst case, multiple federation users may host only the data of a single subject, thus that subject's data distribution can be exposed even if individual users' participation is obfuscated.

### Differential Privacy Definition

Differential Privacy bounds the maximum impact a single data item can have on the output of a randomized algorithm. A randomized algorithm [symbol] : [symbol] → [symbol] is said to be (ε,δ)-differentially private if for any two adjacent datasets [symbol] , [symbol] ′∈ [symbol] and set S⊆ [symbol] ,

[symbol]

[symbol]

( [symbol] )∈∈S)≤e^{ε} [symbol] [symbol] ( [symbol] ))∈S)+δ

where z,34 , [symbol] ′ are adjacent to each other if they differ from each other by a single data item.

Let [symbol] be the set of n users participating in a federation, and [symbol] ᵢ be the dataset of user uᵢ∈ [symbol] . Let [symbol] ᵤ=∪ⁿᵢ₌₁ [symbol] ᵢ. Let [symbol] be the domain of models resulting from the Federated Learning training process. Given a Federated Learning training algorithm [symbol] : [symbol] ᵤ→ [symbol] , [symbol] is user-level (ε, δ)-differentially private if for any two adjacent user sets U, [symbol] ′⊆ [symbol] and [symbol] ⊆ [symbol] ,

[symbol]

( [symbol] ( [symbol] _{U})∈ [symbol] )≤e^{ε} [symbol] ( [symbol] ( [symbol] [symbol] _{′})∈ [symbol] )+δ

where U, [symbol] ′ are adjacent user sets differing by a single user.

Let S be the subjects whose data is hosted by the federation's users [symbol] . Given a Federated Learning training algorithm [symbol] : [symbol] ᵤ→ [symbol] , [symbol] is subject-level (ε, δ)-differentially private if for any two adjacent subject sets S, S′⊆S and [symbol] ⊆ [symbol] ,

[symbol]

[symbol]

( [symbol] _{S})∈ [symbol] )≤e^{ε} [symbol] ( [symbol] [symbol] _{S′})∈ [symbol] )+δ

where S and S′ are adjacent subject sets if they differ from each other by a single subject. This definition is independent of users in a federation and is crucial to make the definition work when (a) a subject's data items are confined to a single user (e.g. for cross-device Federated Learning settings), and (b) a subject's data items are spread across multiple users.

Guaranteeing item-level Differential Privacy in a randomized algorithm [symbol] is insufficient for subject-level Differential Privacy since item-level Differential Privacy obfuscates just a single data item's contribution to [symbol] 's output, whereas hiding a subject may entail obfuscation of multiple data items belonging to that subject. Similarly, guaranteeing user-level Differential Privacy in [symbol] is insufficient for subject-level Differential Privacy since user-level Differential Privacy obfuscates a single user's contribution [symbol] 's output, whereas hiding a subject may entail obfuscation of multiple users' data items belonging to that subject. To enforce subject-level Differential Privacy, the effects of data items belonging to the same subject may be obfuscated.

Any (ε, δ)-differentially private randomized algorithm [symbol] is ( [symbol] ε, [symbol] e^{(g-1)ε}δ)-differentially 0private for groups of size [symbol] . That is, given two [symbol] -adjacent datasets [symbol] and [symbol] ′, and [symbol] ∈ [symbol] where [symbol] is the output space domain,

[symbol]

( [symbol] ( [symbol] )∈ [symbol] )≤e [symbol] ^{ε} [symbol] ( [symbol] ( [symbol] ′)∈ [symbol] )+

[symbol]

where [symbol] and [symbol] ′ are [symbol] -adjacent if they differ from each other in g data items. This may be restated as any (E,Δ)-group differentially private algorithm [symbol] , for a group size of [symbol] , is (E/ [symbol] , Δ/( [symbol] )-differentially private.

In the Federated Learning setting, subject-level Differential Privacy immediately follows from group Differential Privacy for every sampled mini-batch of data items at every federation user. Let S be a sampled mini-batch of data items at a user uᵢ and [symbol] be the domain space of the machine learning model being trained in the Federated Learning setting.

Let training algorithm [symbol] [symbol] :S→ [symbol] be group differentially private for groups of size [symbol] , and [symbol] be the largest number of data items belonging to any single subject in S. If [symbol] ≤ [symbol] , then [symbol] [symbol] is subject-level differentially private.

Composition of group Differential Privacy guarantees over multiple mini-batches and training rounds also follows established Differential Privacy composition results. For instance, the moments accountant method shows that given an (ε, δ)-Differential Privacy gradient computation for a single mini-batch, the full training algorithm, which consisting of T mini-batches and a mini-batch sampling fraction of q, is (O(qe√T), δ)-differentially private. This shows that the same algorithm is (O( [symbol] qe√T, [symbol] e^{(g-1)}^{_{ε}}δ)-group differentially private for a group of size [symbol] .

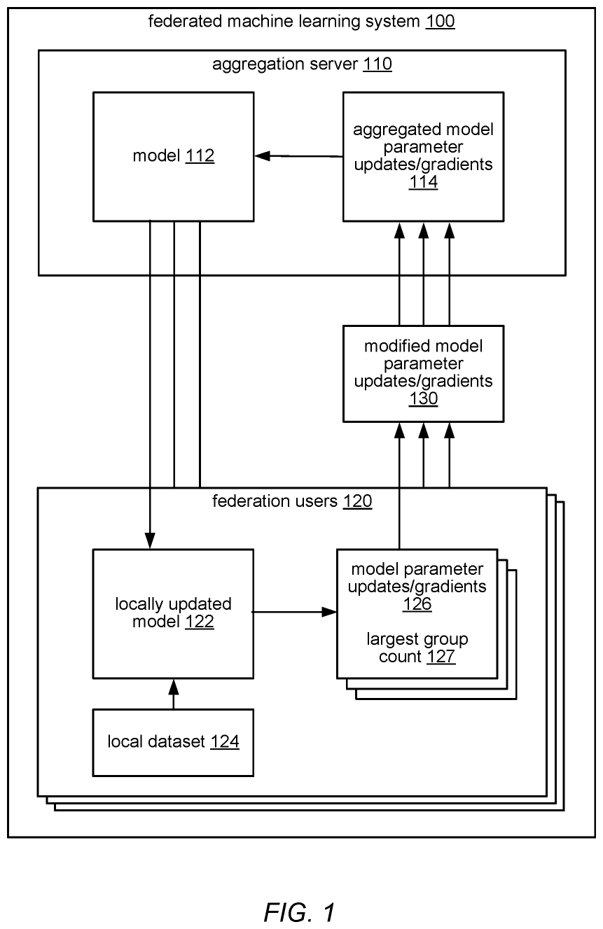

FIG. 1 is a block diagram illustrating a collaborative, federated machine learning system that enables multiple users to cooperatively train a machine learning (ML) model without sharing private training data, in various embodiments.

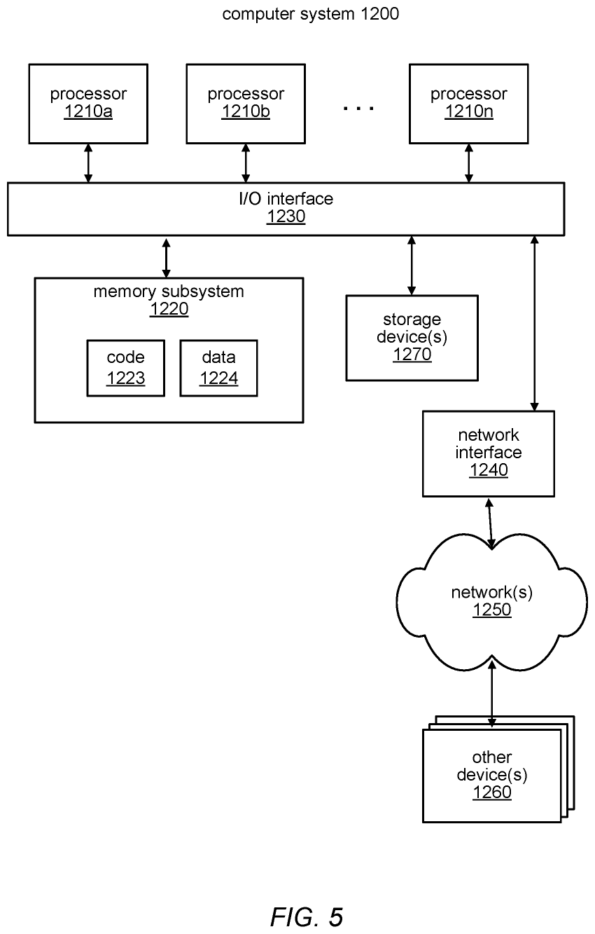

A federated machine learning system 100 may include a central aggregation server 110 and multiple federation users 120. The respective server 110 and users 120 may be implemented, for example, by computer systems 1200 (or other electronic devices) as shown below in FIG. 5. The aggregation server 110 may maintain a machine learning model 112 and, to perform training, may distribute a current version of the machine learning model 112 to the federation users 120.

After receiving a current version of the machine learning model 112, individual ones of the federation users 120 may independently generate locally updated versions of the machine learning model 122 by training the model using local, private datasets 124. This independently performed training may then, for individual mini-batches of the private dataset, generate model parameter updates/gradients 126 and may also generate count(s) 127 representing a largest number of items associated with any subject in their local dataset mini-batches 124.

Noise may then be applied to respective model parameter updates/gradients 126 to generate modified model parameter updates/gradients 130. This noise may be applied in accordance with the respective counts 127 representing the largest number of items associated with a subject in the sampled mini-batch. In some embodiments, this modifying step may be performed individually by federation users 120 while in other embodiments the step may be performed by the aggregation server 110.

Once the modified model parameter updates/gradients 130 have been generated, the modified model parameter updates/gradients 130 may then be sent to the central aggregation server 110.

Upon receipt of the collective modified model parameter updates/gradients 130, the central aggregation server 110 may then aggregate the respective modified model parameter updates/gradients 130 to generate aggregated model parameter updates/gradients 114. The central aggregation server 110 may then apply the aggregated model parameter updates/gradients 114 to the current version of the model 112 to generate a new version of the model 112. This process may be repeated a number of times until the model 112 converges or until a predetermined threshold number of iterations is met.

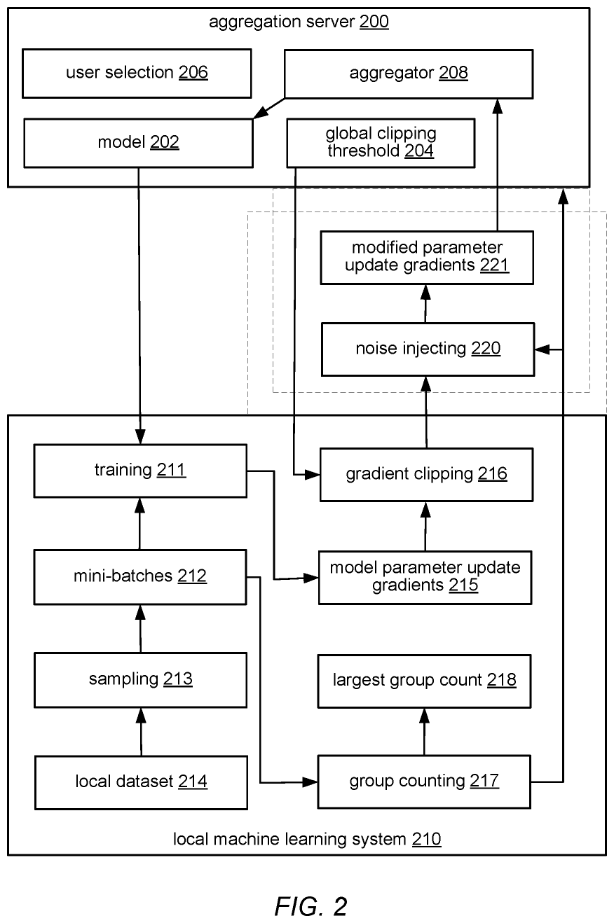

FIG. 2 is a block diagram illustrating a local machine learning system that functions as a user of a collaborative, federated machine learning to cooperatively train a machine learning model without sharing private training data, in various embodiments. As shown in FIG. 2, a local machine learning system may function as a user of a federate machine learning system, such as a federation user 120 of a federated machine learning system 100 as shown in FIG. 1, by coordinating with an aggregation server 200, such as the aggregation server 110 as shown in FIG. 1. The aggregation server 200 and local machine learning system 210 may be implemented, for example, by computer systems 1200 (or other electronic devices) as shown below in FIG. 5.

The aggregation server 200 may provide a machine learning model 202, such as the model 112 of FIG. 1, and a global clipping threshold 204 to the local machine learning system 210 for training responsive to selecting the local machine learning system 210 to participate as a user in a particular training round using the user selection component 206 of the aggregation server 200. Federated machine learning systems may employ multiple training rounds in the training of a machine learning model, in some embodiments, where different sets of federated users are selected in the respective training rounds.

An aggregator component 208 of the aggregation server 200 may, in some embodiments, collect parameter update gradients 221 from multiple federation users selected in the particular training round using the user selection component 206 and aggregate the various parameter update gradients 221 to generate aggregated model parameter updates, such as the aggregated model parameter updates/gradients 114 as shown in FIG, 1, to update the model 202.

A machine learning training component 211 of the local machine learning system 210 may receive the model 202 and further train the model using a local dataset 214 to generate a locally updated version of the machine learning model 202, such as the locally updated model 122 as shown in FIG. 1. To train the model with the local dataset, the local machine learning system 210 may sample the local dataset 214 into one or more subsets of the dataset, also known as mini-batches 212, using a sampling component 213.

In some embodiments, a mini-batch 212 may be of a fixed batch size, with the batch size chosen for a variety of reasons in various embodiments, including, for example, computational efficiency, machine learning model convergence rate, and training accuracy. It should be understood, however, that these are merely examples and that other parameters for choosing the mini-batch size may be imagined.

In some embodiments, the locally updated version of the machine learning model 202 may generate a set of model parameter update gradients 215, such as the model parameter updates/gradients 126 as shown in FIG. 1. These model parameter update gradients may then be clipped at a parameter clipping component 216 according to a global clipping threshold 204 provided by the aggregation server 200, in some embodiments. This global clipping threshold 204 may be selected by the aggregation server for a variety of reasons in various embodiments, including, for example, machine learning model convergence rate and training accuracy. It should be understood, however, that these are merely examples and that other parameters for choosing the threshold c may be imagined. This clipping of the parameter updates according to the provided global clipping threshold 204 may bound sensitivity of the aggregated federated learning model to the model parameter update gradients, in some embodiments.

Additionally, in some embodiments the local machine learning system 210 may, as shown in 217, count items in the mini-batch 212 belonging to various groups to determine a largest group count 218. This largest group count 218 may then be used to determine an amount of noise proportional to the largest group count to inject into the model parameter update gradients by a noise injecting component 220 to generate modified model parameter update gradients 221, such as the modified model parameter updates/gradients 130 as shown in FIG. 1, the modified model parameter update gradients 221 ensuring differential privacy for the local machine learning system 210 dataset 214.

In some embodiments, the amount of noise may be further calibrated according to the same global clipping threshold 204 parameter provided by the aggregation server 200 such that the noise injected is calibrated to the sensitivity of the aggregated federated learning model. By injecting noise calibrated to the sensitivity of the aggregated federated learning model, the local machine learning system may provide differential privacy guarantees for its own local dataset without coordination of the aggregation server 200.

Differential privacy may be enforced either globally, by the aggregation server 200, or locally, by each local machine learning system 210. In some embodiments, the selection of enforcement may be determined by assumptions made about the trust model between the aggregation server 200 and its users.

Global differential privacy enforcement may be preferred in cases where the users trust the aggregation server 200. In such embodiments, the noise injecting 220 step may performed by the aggregation server 200 to generate the modified parameter update gradients 221 within the aggregation server 200. In other embodiments, where local differential privacy enforcement may be preferred due to a lack of trust between users and the aggregation server 200, or where lack of trust between users and the aggregation server 200 must be assumed, the noise injecting 220 step may performed by each local machine learning system 210 to generate the modified parameter update gradients 221 within each local machine learning system 210.

### Central Subject Differential Privacy

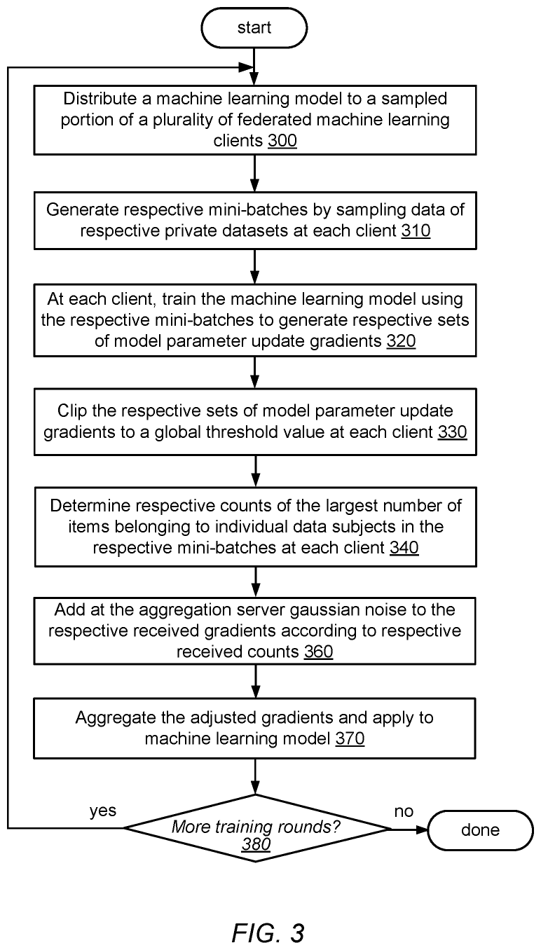

FIG. 3 is a block diagram illustrating an embodiment implementing a federated machine learning system providing centralized subject-level Differential Privacy (Differential Privacy), in various embodiments. Embodiments of FIG. 3 may implement the following pseudo code:

User_CentralSubDifferential Privacy(uᵢ):

S = random sample of [symbol] data items from

[symbol]

| | |
|---|---|
| for sᵢ ∈ S do | |
| [symbol] (sᵢ)= ∇ [symbol] (θ, sᵢ) | // Compute gradients |
| ĝ(sᵢ) = Clip( [symbol] (sᵢ) , C) | // Clip gradients |
| end | |
| Z = LrgGrpCnt(S) | |
| return (1/ [symbol] )Σᵢĝ(sᵢ) , Z | |
| Server_CentralSubDifferential Privacy( ): | |
| for r = 1 to R do | |
| Uₛ = sample s users from [symbol] | |
| [symbol] = 0 | |
| for uᵢ ∈ Uₛ do | |

ĝₛ, Z = User_CentralSubDifferential Privacy(uᵢ)

```
      ĝₛ = ĝₛ + (1/ [symbol]  ) [symbol]  (0, σ²_{Z}C²I) [symbol]
      = [symbol]  + ĝₛ
    end
    θ = θ - η [symbol]   /s
    send M to all users in [symbol]
  end
For:
  Set of n users [symbol]  = u₁, u₂, ..., uₙ [symbol]
  the dataset of user uᵢ
  M the model to be trained
  θ the parameters of model M
  gradient norm bound C
  sample of users Uₛ
  mini-batch size B
  largest group size in a mini-batch Z
  noise scale σ_{Z} for group size Z
  R training rounds
  learning rate η
```

A federation server may randomly sample a set of users and sends them a request to train a current version of a machine learning model. Each user in turn computes gradients of a randomly selected mini-batch of local data, and then returns the gradients to the federation server. Along with mini-batch gradients, the federation user returns the largest item count for that mini-batch to the federation server. The count lets the federation server know the group size needed to enforce group Differential Privacy for that mini-batch.

This group size Z may be used to determine a noise scale given the target privacy parameters over the entire training computation. More specifically, a moments accountant method may be used to compute σ for ε=ε/Z, and δ=Δ/(Ze^{(Z-1)e/Z}). Note that the value of Z can vary between mini-batches.

The federation server accumulates the received gradients, adds appropriate amount of noise to gradients received from each user, averages the adjusted gradients over all responses from users, applies the averaged adjusted gradients to its common model, and then redistributes the updated model to the users. This is a single training round. The federation server repeats this process until convergence or a threshold number of training rounds has elapsed.

The process begins at step 300 where a current version of a machine learning model may be distributed from an aggregation server to a sampled portion of a plurality of clients, such as the model 112 shown in FIG. 1, in some embodiments. Once the model is distributed, as shown in 310, individual clients may generate respective mini-batches, such as the mini-batches 212 as shown in FIG. 2, by sampling data of respective datasets private to the respective clients, in some embodiments.

Individual clients may then train the machine learning model, such as the model 122 shown in FIG. 1, using the respective sampled mini-batches to generate respective sets of model parameter update gradients, such as the model parameter updates/gradients 126 of in FIG. 1, as shown in 320, in some embodiments. The clients may then, as shown in 330, clip the model parameter update gradients to a global clipping threshold value, such as the global clipping threshold 204 as shown in FIG. 2, in some embodiments. The clients may then determine respective counts of the largest number of items belonging to individual data subjects in the respective mini-batches, such as the largest group count 127 of in FIG. 1, as shown in 340.

The process may then proceed to step 360 where the aggregation server may add Gaussian noise to the respective received gradients according to respective received counts of the largest number of items that are associated with any particular subject of within the respective mini-batches, such as in the noise injecting component 220 of FIG. 2, in some embodiments.

The process may then proceed at step 370 where the aggregation server may, for example using the aggregator component 208 shown in FIG. 2, aggregate the adjusted gradients to generate a set of aggregated model parameter update gradients, such as the aggregated model parameter updates/gradients 114 as shown in FIG. 1, and apply the aggregated parameter update gradients to the machine learning model to generate a new version of the machine learning model, in some embodiments.

If more training rounds are needed, such as determined by model convergence or by a number of rounds completed compared to a threshold number of rounds, as shown in a positive exit from 380, the process may then return to test 300. If more training rounds are not needed, as shown in a negative exit from 380, the process is then complete.

### User Local Subject Differential Privacy

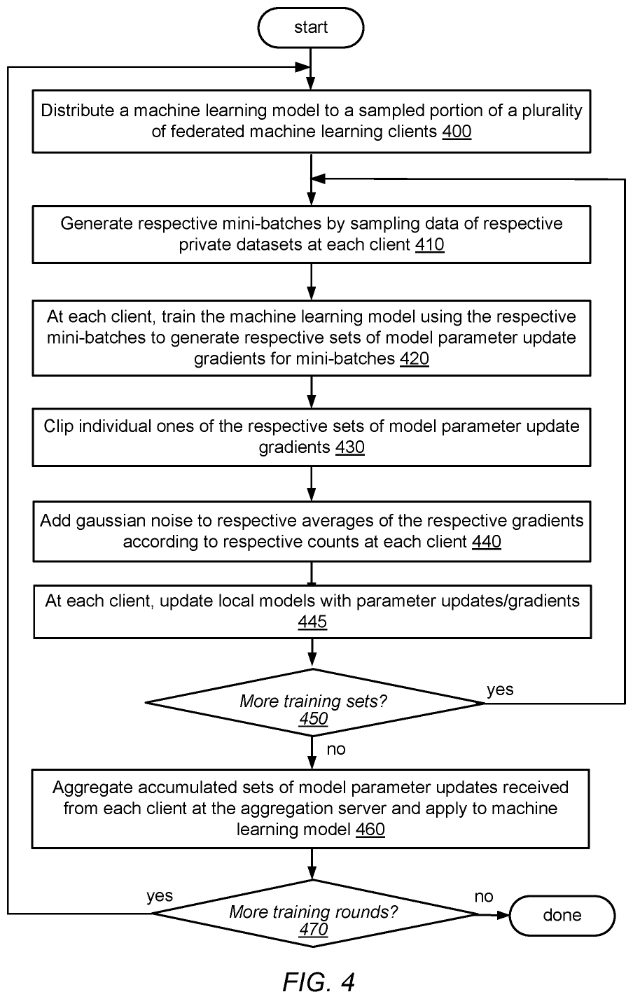

FIG. 4 is a block diagram illustrating another embodiment implementing a federated machine learning system providing subject-level local differential privacy, in various embodiments. Embodiments of FIG. 4 may implement the following pseudo code:

User_LocalSubCP(uᵢ):
for t = 1 to T do

S = random sample of [symbol] data items from

[symbol]

| | |
|---|---|
| for sᵢ ∈ S do | |
| [symbol] (sᵢ)= ∇ [symbol] (θ, sᵢ) | // Compute gradients |
| ĝ(sᵢ) = Clip( [symbol] (sᵢ) , C) | // Clip gradients |
| end | |
| Z = LrgGrpCnt(S) | |
| ĝₛ = (1/ [symbol] )Σᵢĝ(sᵢ) + [symbol] (0, σ²_{Z}C²I)) | |
| θ = θ - η ĝₛ/s | |
| end | |
| return θ | |
| ServerLocalSubCP( ): | |
| for r = 1 to R do | |
| Uₛ = sample s users from [symbol] | |
| for uᵢ ∈ Uₛ do | |
| θᵢ = User_LocalSubCP(uᵢ) | |
| end | |
| θ = (1/s) Σᵢθᵢ | |
| send M to all users in [symbol] | |
| end | |
| For: | |
| Set of n users [symbol] = u₁, u₂, ..., uₙ | |
| [symbol] the dataset of user uᵢ | |
| M the model to be trained | |
| θ the parameters of model M | |
| gradient norm bound C | |
| sample of users Uₛ | |
| mini-batch size B | |
| largest group size in a mini-batch Z | |
| noise scale σ_{Z} for group size Z | |
| R training rounds | |
| learning rate η | |

The federation server may sample a random set of users for each training round and send them a request to perform local training. Each user may in turn train for a multitude of mini-batches and introduce carefully calibrated Gaussian noise in parameter gradients computed for each mini-batch. For each mini-batch, gradients may be computed for each data item separately, then clipped to the threshold C to bound the gradients' sensitivity. The gradients are then summed over the full mini-batch, and Gaussian noise, scaled to C and the group size Z, is added to the sum. This sum may then be averaged over the mini-batch size and applied to the parameters. This process may be repeated for each of the multitude of mini-batches. The users may then send back updated model parameters to the federation server which then simply averages the updates received from all the sampled users. The server redistributes the updated model and triggers another training round if needed.

Each mini-batch may be analyzed to determine a group size Z representing the largest number of items of any subject appearing in the mini-batch. Z may then be used to compute the appropriate noise value which may be subsequently added to the mini-batch gradients' sum before averaging.

The process begins at step 400 where a current version of a machine learning model may be distributed from an aggregation server to a sampled portion of a plurality of clients, such as the model 112 shown in FIG. 1, in some embodiments. Once the model is distributed, as shown in 410, individual clients may generate respective mini-batches, such as by using the sampling component 213 to generate mini-batches 212 as shown in FIG. 2, by sampling data of respective datasets private to the respective clients, in some embodiments.

Individual clients may then train the machine learning model, such as the model 122 shown in FIG. 1, using the respective sampled mini-batches to generate respective sets of model parameter update gradients, such as the model parameter updates/gradients 126 of in FIG. 1, as shown in 420, in some embodiments. The clients may then, as shown in 430, clip the respective sets of model parameter updates, for example as shown in gradient clipping 216 of FIG. 2, in some embodiments.

The process may then proceed to step 440 where the clients may then add gaussian noise, such as in the noise injecting component 220 of FIG. 2, to the respective accumulated sets of model parameter updates/gradients, such as the model parameter updates/gradients 130 of in FIG. 1, as shown in 440, in some embodiments. This noise may be added in accordance with the respective counts, such as the largest group count 127 of FIG. 1, representing the largest number of items associated with a subject in the local datasets, in some embodiments. Then, as shown in 445, the accumulated sets of model parameter updates/gradients may be applied by the individual clients to update the respective local models, in some embodiments.

If more mini-batches are needed, as shown in a positive exit from 450, the process may then return to test 410. If more mini-batches are not needed, as shown in a negative exit from 450, the process may then proceed to step 460 where the aggregation server may aggregate the sets of model parameter updates received from the respective clients, such as the aggregated model parameter updates/gradients 114 shown in FIG. 1, and apply the aggregated parameter updates to the machine learning model to generate a new version of the machine learning model, as shown in 460.

If more training rounds are needed, such as determined by model convergence or by a number of rounds completed compared to a threshold number of rounds, as shown in a positive exit from 470, the process may then return to test 400. If more training rounds are not needed, as shown in a negative exit from 470, the process is then complete.

### Example Computing System

Some of the mechanisms described herein may be provided as a computer program product, or software, that may include a non-transitory, computer-readable storage medium having stored thereon instructions which may be used to program a computer system 1200 (or other electronic devices) to perform a process according to various embodiments. A computer-readable storage medium may include any mechanism for storing information in a form (e.g., software, processing application) readable by a machine (e.g., a computer). The machine-readable storage medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; electrical, or other types of medium suitable for storing program instructions. In addition, program instructions may be communicated using optical, acoustical or other form of propagated signal (e.g., carrier waves, infrared signals, digital signals, etc.)

In various embodiments, computer system 1200 may include one or more processors 1210; each may include multiple cores, any of which may be single- or multi-threaded. For example, multiple processor cores may be included in a single processor chip (e.g., a single processor 1210), and multiple processor chips may be included in computer system 1200. Each of the processors 1210 may include a cache or a hierarchy of caches (not shown) in various embodiments. For example, each processor chip 1210 may include multiple L1 caches (e.g., one per processor core) and one or more other caches (which may be shared by the processor cores on a single processor).

The computer system 1200 may also include one or more storage devices 1270 (e.g. optical storage, magnetic storage, hard drive, tape drive, solid state memory, etc.) and a memory subsystem 1220. The memory subsystem 1220 may further include one or more memories (e.g., one or more of cache, SRAM, DRAM, RDRAM, EDO RAM, DDR RAM, SDRAM, Rambus RAM, EEPROM, etc.). In some embodiments, one or more of the storage device(s) 1270 may be implemented as a module on a memory bus (e.g., on I/O interface 1230) that is similar in form and/or function to a single in-line memory module (SIMM) or to a dual in-line memory module (DIMM). Various embodiments may include fewer or additional components not illustrated in FIG. 5 (e.g., video cards, audio cards, additional network interfaces, peripheral devices, a network interface such as an ATM interface, an Ethernet interface, a Frame Relay interface, etc.)

The one or more processors 1210, the storage device(s) 1270, and the memory subsystem 1220 may be coupled to the I/O interface 1230. The memory subsystem 1220 may contain application data 1224 and program code 1223. Application data 1224 may contain various data structures while program code 1223 may be executable to implement one or more applications, shared libraries, and/or operating systems.

Program instructions 1225 may be encoded in a platform native binary, any interpreted language such as Java™ byte-code, or in any other language such as C/C++, the Java™ programming language, etc., or in any combination thereof. In various embodiments, applications, operating systems, and/or shared libraries may each be implemented in any of various programming languages or methods. For example, in one embodiment, operating system may be based on the Java™ programming language, while in other embodiments it may be written using the C or C++ programming languages. Similarly, applications may be written using the Java™ programming language, C, C++, or another programming language, according to various embodiments. Moreover, in some embodiments, applications, operating system, and/shared libraries may not be implemented using the same programming language. For example, applications may be C++ based, while shared libraries may be developed using C.

What is claimed is:

1. A computer-implemented method, comprising:
receiving, at a plurality of clients of a federated machine learning system, a federated learning model from an aggregation server of the federated machine learning system;
performing at respective clients of the plurality of clients:
training the received machine learning model using a portion of a dataset private to the respective client to generate one or more parameter updates;
determining a count of the largest number of items in the portion of the private dataset associated with any single group of one or more groups of the portion of the dataset; and
sending data representing the one or more parameter updates to the aggregation server;
applying respective noise values, according to the determined respective counts of the largest number of items, to individual ones of the one or more parameter updates;
receiving, at the aggregation server, the respective data representing the parameter updates from the plurality of clients; and
revising the federated learning model according to an aggregation of the respective received data representing the parameter updates of the plurality of clients.

2. The computer-implemented method or claim 1, wherein the applying of the respective noise values is performed by the respective clients prior to said sending.

3. The computer-implemented method or claim 1, further comprising sending, from the respective clients of the plurality of clients, the respective counts of the largest number of items to the aggregation server, and wherein the applying of the respective noise values is performed by the aggregation server subsequent to receiving the respective data representing the parameter updates and the respective counts from the plurality of clients.

4. The computer-implemented method of claim 1, wherein the applying of the respective noise values to the individual ones of the one or more parameter updates comprises determining the respective noise values in proportion to the respective counts of the largest number of items.

5. The computer-implemented method of claim 1, wherein applying the respective noise values according to the respective counts to the individual ones of the one or more parameter updates provides differential privacy for the private dataset of the respective client.

6. The computer-implemented method of claim 1, wherein the receiving, training, determining, sending, applying, receiving and revising are performed for a single training round of a plurality of training rounds of the federated machine learning system, and wherein individual ones of the plurality of training rounds use different portions of the plurality of clients.

7. The computer-implemented method of claim 1, wherein training the received machine learning model comprises using a mini-batch of the dataset private to the respective client to generate the one or more parameter updates.

8. A system, comprising:
a plurality of clients of a federated machine learning system, wherein individual clients of portion of the plurality of clients are configured to:
receive a federated learning model from an aggregation server of the federated machine learning system;
train the received machine learning model using a portion of a dataset private to the respective client to generate one or more parameter updates;
determine a count of the largest number of items in the portion of the private dataset associated with any single group of one or more groups of the portion of the dataset; and
send data representing the one or more parameter updates to the aggregation server;
the aggregation server of the federated machine learning system, configured to:
collect the respective data representing the parameter updates from the plurality of clients; and
revise the federated learning model according to an aggregation of modified data representing the parameter updates of the plurality of clients, the modified data comprising the received data representing the parameter updates of the plurality of clients with applied respective noise values, the respective noise values determined according to the respective counts of the largest number of items.

9. The system of claim 8, wherein the individual clients of portion of the plurality of clients are further configured to apply the respective noise values to individual ones of the one or more parameter updates.

10. The system of claim 8, wherein the aggregation server is further configured to apply the respective noise values to individual ones of the one or more parameter updates.

11. The system of claim 8, wherein the respective noise values are proportional to the respective counts of the largest number of items.

12. The system of claim 8, wherein the applied respective noise values provide differential privacy for the private dataset of the respective client.

13. The system of claim 8, wherein the receiving, training, determining, sending, collecting and revising are performed for a single training round of a plurality of training rounds of the federated machine learning system, and wherein the federated machine learning system is configured to use different portions of the plurality of clients for respective rounds of the plurality of training rounds.

14. The system of claim 8, wherein to train the received machine learning model the portion of the individual clients of the plurality of clients are configured to train the received machine learning model using a mini-batch of the dataset private to the respective client to generate the one or more parameter updates.

15. One or more non-transitory computer-accessible storage media storing program instructions that when executed on or across one or more computing devices cause the one or more computing devices to perform:
receiving, at a client of a plurality of clients of a federated machine learning system, a federated learning model from an aggregation server of the federated machine learning system; and
performing at the client:
training the received machine learning model using a dataset private to the respective client to generate one or more parameter updates;
determining a count of the largest number of items in the portion of the private dataset associated with any single group of one or more groups of the portion of the dataset; and
sending the one or more parameter updates to the aggregation server to revise the federated learning model according to an aggregation of modified data representing the parameter updates of the plurality of clients, the modified data comprising the received data representing the parameter updates of the plurality of clients with applied respective noise values, the respective noise values determined according to the respective counts of the largest number of items.

16. The one or more non-transitory computer-accessible storage media of claim 15 storing additional program instructions that when executed on or across the one or more computing devices cause the one or more computing devices to perform applying the respective noise values to individual ones of the one or more parameter updates.

17. The one or more non-transitory computer-accessible storage media of claim 16, wherein applying the respective noise values to individual ones of the one or more parameter updates provides differential privacy for the private dataset of the respective client.

18. The one or more non-transitory computer-accessible storage media of claim 16 storing additional program instructions that when executed on or across the one or more computing devices cause the one or more computing devices to perform determining the respective noise values according to the respective counts of the largest number of items.

19. The one or more non-transitory computer-accessible storage media of claim 17, wherein the respective noise values are determined according to a gaussian distribution.

20. The one or more non-transitory computer-accessible storage media of claim 15, wherein training the received machine learning model comprises using a mini-batch of the dataset private to the respective client to generate the one or more parameter updates.
